(19) United States
(12) Patent Application Publication
(10) Pub. No.: US 2007/0287652 A1
(43) Pub. Date: Dec. 13, 2007

(54) Systems and methods for making stable, cotton-gentle chlorine bleach and products thereof

(75) Inventor: Lawnie H. Taylor, Germantown, MD (US)

Correspondence Address: NIXON PEABODY, LLP, 401 9TH STREET, NW, SUITE 900, WASHINGTON, DC, 20004-2128, US

(73) Assignee: LHTaylor Assoc, Inc., Germantown, MD (US)

(21) Appl. No.: 11/447,954

(22) Filed: Jun. 7, 2006

(51) Int. Cl. C11D 3/00

(52) U.S. Cl. 510/380

(57) ABSTRACT

A system, product and methodology for making bleach cotton-gentle. A sodium hydroxide additive, which consumers can combine with household bleach, creates a bleach having the same strength as the household bleach but also cotton-gentle, and having significantly prolonged useful shelf life. The present invention also describes a system and methodology for the additive combination, and a system, product and a process for the production of large volumes of industrial strength bleach (sodium hypochlorite at about 11% to 16% by weight with appropriate dilution to about 5.25% to about 6% by weight) with inherent properties of chemical stability and cotton tolerance compatible with the requirements of laundry use.

### CROSS-REFERENCE TO RELATED APPLICATIONS

U.S. patent application Ser. No. 10/337,896, now U.S. Pat. No. 6,774,098, filed Jan. 8, 2003, entitled “Methods for Removing Stains From Fabrics Using Tetrapotassium EDTA,” which claims priority to U.S. Provisional Application Ser. No. 60/423,978, filed Nov. 6, 2002, entitled “A Subclass of Aqueous, Hard Surface Cleaners Used in A New and Unobvious Soft Surface Cleaning Application,” both of which are incorporated by reference herein. The present application also incorporates by reference U.S. patent application Ser. No. 10/612,016, filed Jul. 3, 2003, and U.S. patent application Ser. No. 10/373,787, filed Feb. 27, 2003, now U.S. Pat. No. 6,946,435, both of which are entitled “Methods and Equipment for Removing Stains from Fabrics.” Finally, the present application incorporates by reference U.S. patent application Ser. No. 11/101,433, filed Apr. 8, 2005, entitled “Formation of Patterns of Fades on Fabrics.”

### BACKGROUND OF THE INVENTION

One of the best known laundry cleansing agents used by consumers is the commodity known as sodium hypochlorite or “bleach,” commonly available at retail stores under several popular brand names which, herein, are referred to collectively as “chlorine bleach products.” Two uses for chlorine bleach products that are of major importance to consumers are:

(1) Laundry Use
Remove stains from laundry items (principally, cotton).

(2) Household Use
Disinfectant cleaning of bathroom/kitchen fixtures, tiles, and floors.

Applicant has discovered a sodium hypochlorite blend with properties much improved over those of chlorine bleach products. This discovery is referred to herein as “bleach blend.”

For over ninety years, chlorine bleach products have been applied to household and laundry uses. As is readily known to consumers, chlorine bleach products are not generally dilution does not significantly hamper the active effectiveness of a chlorine bleach product as a good disinfectant and cleaning agent for household use, dilution does cause a major problem for laundry use in that:

(1) Dilution slows stain removal effectiveness. Dilution is, however, essential because, unless highly diluted with water, chlorine bleach products are very harsh and damaging to cotton and related fabrics. Indeed, commercially-available bleach products instruct users to dilute one-quarter cup of their bleach product with one gallon of water for pretreatment of fabric stains. Apparel manufacturers customarily tag their cotton items with a warning to avoid the use of chlorine bleach, whether diluted or undiluted.

Another problem relates to both household and laundry uses:

(2) Chlorine bleach products suffer significant loss of useful shelf life at ordinary temperatures. The useful shelf life is expected to be approximately six months at ordinary temperatures, and much less if exposed to elevated temperatures.

From the foregoing, it is clear that although chlorine bleach products are reasonably suited to household use, consumers also need chlorine bleach specifically suited for laundry use with better properties. Additionally, it would be useful that such products can be applied at full bottle strength without damaging cotton fabric and that the products have a useful shelf life for longer than six months.

Through Applicant's research, Applicant has discovered that cotton fabric immersed in Applicant's bleach blend (undiluted) retains its tensile and tear strength over ten times longer than cotton fabric immersed in chlorine bleach products (undiluted). Indeed, it has found that Applicant's bleach blend can be used at full strength (undiluted) for the pretreatment of stains on cotton fabric (white or fast colored) such as to rapidly and completely remove stains without damage to the fabric.

Based upon empirical data, Applicant has also found that the useful shelf life of bleach blend, made pursuant to the teachings of the present invention, is at least one year at ordinary temperatures.

Applicant, therefore, believes that the bleach blend of the present invention, which is both cotton gentle and longer lasting, is a chlorine bleach much better suited for laundry use, and overcomes the aforementioned deleterious effects of fabric damage and limited shelf life plaguing existing chlorine bleach products.

From the foregoing, it is evident that the institutional practice of combining laundry and household use purposes in the same packaged chloride bleach product does not truly meet the consumer need. It follows that two different bleach solutions are required, one for laundry use and one for household use. Herein is described a simple system and methodology whereby consumers can convert the household use properties of any chlorine bleach product to have the advantageous properties of bleach blend, specifically suited for laundry use.

The present application also describes a modification which converts the standard industrial chemical process for the production of household-use chlorine bleach product to a process for the industrial production of laundry-use bleach blend, as set forth in more detail hereinbelow.

### SUMMARY OF THE INVENTION

The present invention sets forth an economically-viable system, product and methodology that enables consumers to convert their unstable, cotton-damaging (unless highly diluted with water) chlorine bleach product of choice to a stable, cotton-gentle (at full-strength) bleach blend useful and suitable for laundry use. The present invention is also directed to a simple, economically-viable modification to the standard industrial chemical systems and processes for the production of sodium hypochlorite that enables the industrial production of stable, cotton-gentle bleach blend suitable for laundry use and to the products of those processes. The present invention is also directed to a system and methodology for simplifying production of an improved bleach blend, and to the products of those processes.

Other features, objects, and advantages of the present invention are apparent in the detailed description that follows. It should be understood, however, that the detailed description, while indicating preferred embodiments of the present invention, is given by way of illustration only, not limitation. Various changes and modifications within the scope of the invention will become apparent to those skilled in the art from the detailed description.

### BRIEF DESCRIPTION OF THE DRAWINGS

The features, aspects, and advantages of the present invention will become better understood with regard to the following description, appended claims, and accompanying Drawings where:

FIGS. 1A and 1B generally illustrate a first embodiment for using the additive pursuant to the present invention; and

FIG. 2 generally illustrates a flowchart of a process for the production of the bleach blend composition pursuant to the teachings of the present invention.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

As is known in the art and set forth in considerable detail in Applicant's prior applications, referred to hereinabove and incorporated by reference herein, commercial-strength chlorine bleach products contain two primary ingredients: sodium hypochlorite (about 5.25%-6%, by weight) and water. Another ingredient, sodium hydroxide, is also present in trace amounts at a concentration typically less than about 0.2% by weight. The pH of commercial-strength chlorine bleach products, of a variety of brands, is generally at about 11.4.

As discussed above, it is widely accepted that chlorine bleach products are good disinfectants, but that they also are harsh and damaging to cotton. In addition, the useful shelf life of chlorine bleach products is limited because the sodium hypochlorite ingredient steadily loses its strength due to its reaction with the water of the solution, forming sodium hydroxide and the unstable hypochlorous acid. It is a sub-product of hypochlorous acid, highly oxidative nascent oxygen, that is most likely responsible for both the disinfectant and cotton damaging properties of all chlorine bleach products on the market.

Applicant has found that if quantities of sodium hydroxide are admixed with a commercially-available chlorine bleach product, the sodium hypochlorite and water reaction described hereinabove is reversed, thus significantly decreasing the rate of decomposition of the sodium hypochlorite and thereby decreasing the rates of formation of hypochlorous acid and its by-product nascent oxygen in the admixture which otherwise are present at deleterious levels in commercial chlorine bleach products. Applicant also found that the resultant admixture solution is similar to Applicant's aforementioned bleach blend described in more detail hereinbelow, which has the important laundry use properties of fabric-gentleness and stability.

Commercial-strength bleach blend pursuant to the present invention contains several ingredients: sodium hypochlorite (typically about 6% by weight), sodium hydroxide (about 3% by weight) and water, the solution being at a pH greater than about 13. As is readily apparent to those skilled in the chemical arts, the concentration of sodium hydroxide in the bleach blend is more than an order of magnitude greater than that found in commercially-available chlorine bleach products. As noted previously by Applicant, this unusual result was quite unexpected and radically different from all usages of like products on the market, many in use for many decades and well-known commercially A preferred sodium hydroxide concentration of bleach blend according to the present invention, applicable to any concentration of sodium hypochlorite, is given by the following empirical criterion: the sodium hydroxide concentration by weight is equal to about one-half the concentration by weight of sodium hypochlorite.

As also set forth in Applicant's co-pending application, particularly, U.S. Ser. No. 10/612,016, and issued patent, U.S. Pat. No. 6,945,435, cited hereinabove, the present invention is directed to methods and products useful for reducing the damaging effects of chlorine bleach products. These prior applications set forth various compositions and processes to effectuate same, and are incorporated by reference herein.

The instant invention builds upon those innovations making the product more commercially viable and economical for use by everyone in need of an improved laundry bleach that has none or a significantly reduced amount of the highly deleterious effects of commercially-available products in prevalent use today.

It should also be understood that in a first embodiment of the present invention the admixture of sodium hydroxide with a chlorine bleach product, according to the above criterion replicates the aforedescribed bleach blend solution having the advantageous laundry use characteristics.

Methodologies and systems employing the above admixture enable a consumer to convert any chlorine bleach product to have the more cotton-gentle and other beneficial properties of bleach blend. The consumer has only to combine, with the chlorine bleach product of choice, an additive containing an appropriate mass quantity of sodium hydroxide either in solid bead form or in liquid form, in keeping with the industry standards for safety, with a liquid form of rayon-grade quality being the currently preferred form of the additive with a low metal impurities content. Instructions for the determination of the appropriate amount of additive can be supplied with the additive, e.g., in a kit or system. As indicated, the toxicity of sodium hydroxide is a concern in consumer products, and great care must be taken to design a product that is both simple to use and safe.

Accordingly, in one preferred methodology, quantities of 50% by weight sodium hydroxide in liquid form are dispensed as directed, in measured drops, sprays, or volume of liquid, to combine with an appropriate quantity of the chlorine bleach product, according to the aforementioned criterion in order to replicate the bleach blend and its beneficial properties. For example, 16 mL of 50% by weight rayon-grade NaOH combined with each cup (236.5 mL) of undiluted chlorine bleach product results in a bleach blend per the criterion for use as a cotton-gentle fabric pretreatment with rapid and complete removal of stains. In this manner, volumes of the commercial chlorine bleach combined with additive can be admixed, e.g., in a kit or system with appropriate instructions for the safe usage of the components and the particular amounts thereof to attain the desired criterion. For example, a sample of commercial chlorine bleach can be measured out pursuant to the quantity of additive present.

It should also be understood that the additive, in an appropriate quantity, can be combined with a range of volumes of chlorine bleach product, instead of samples from those products, so that the resultant product replicates the fabric safety and stability characteristics of bleach blend pursuant to the teachings of the present invention. Chlorine bleach products for home laundry use are available to consumers in container sizes ranging from pints to gallons. For example, an additive volume of 193.5 mL of sodium hydroxide can be combined with the popular three-quart size chlorine bleach product. The additive is poured into the three quart container chlorine bleach product, and the contents are then immediately converted to a stable, cotton-gentle bleach blend of comparable sodium hypochlorite strength. It should readily be understood that this methodology for volumetric transformation of chlorine bleach products to stable, cotton-gentle bleach blend can be applied to all commercially-available volume sizes of chlorine bleach product with the addition of the appropriate amount of additive pursuant to the aforementioned criterion. In view of the trace amounts of sodium hydroxide in commercial chlorine bleach products, the amount or concentration of sodium hydroxide (or other alkali metal) in the additive is about one-half the concentration of the sodium hypochlorite (or other hypochlorite salt), by weight, in the resultant product.

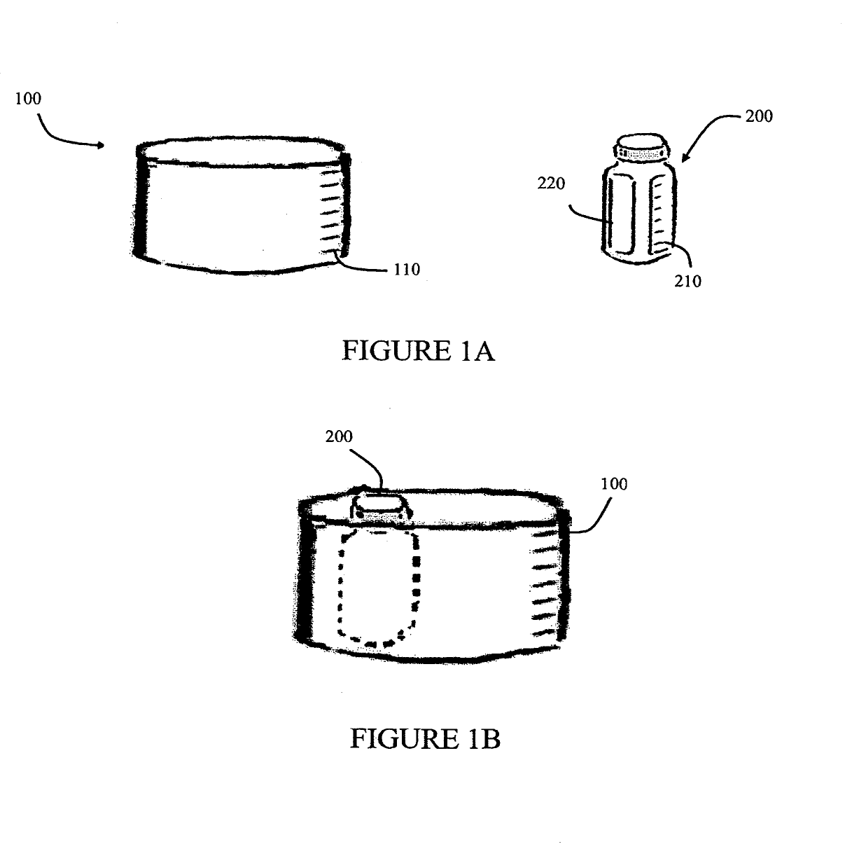

A mechanism for consumer use is illustrated in FIG. 1A, which shows a methodology for facilitating conversion of existing, chlorine bleach products into cotton-gentle bleach blends pursuant to the present invention. A container 100 can be employed to receive a sample volume of chlorine bleach product therein, as indicated by volumetric markers, e.g., pints or quarts, along the side thereof, and generally indicated by the reference numeral 110. A bottle or other container, generally indicated by the reference numeral 200, contains the aforementioned additive composition therein. A number of volumetric markers 210 can be employed to correlate the amount of additive in container 200 to admix with the fluid in container 100, e.g., one or more of the markers 210 can correspond to the aforementioned 16 ml and one of the markers 110 corresponds to the aforementioned 236.5 ml of undiluted chlorine bleach product placed within the container 100 by the consumer (or sold in that size for such admixture). As is understood in the marketing arts, the markers 110 and 210 are selected and delineated in a prominent manner for ease of use.

To facilitate sale of the two components, they can be sold separately or together, preferably with only container 200 containing the additive therein (with the commercial bleach being purchased separately), as shown in FIG. 1B, with the bottle 200 placed inside the empty container 100. It should be understood that small, standard or non-standard amounts of cotton-gentle bleach can be easily prepared using the configuration shown in FIG. 1.

In another preferred embodiment, the container 200 with additive therein can be sold alone, preferable with the markers 210 to guide usage. Of course, the additive in container 200 can also be sold in precise quantities to add to existing volumes of commercial products, in pints or gallons, thereby not requiring markers 210. It should be understood, however, that a label 220 or other indicia will be necessary to provide guidance to consumers using the product, e.g., setting forth desired or suggested admixture quantities pursuant to the aforementioned criterion used with commercial products. To accord with other safety precautions, statutorily-mandated and otherwise, warnings will also be provided to better facilitate proper usage of the product.

At present, a variety of container 200 sizes are possible, e.g., the. aforementioned 193.5 ml of 50% sodium hydroxide for combination with a three-quart container or lesser sizes with less additive, i.e., usage of the aforementioned markers 210 to delineate gallon or other discrete additive sizes.

It should, of course, also be understood that the system and methodology of the present invention also can be applied to industrial concentrations of sodium hypochlorite solutions contained in drum, tote, and tank sizes. In such application, the additive volume remains consistent with the aforementioned criterion.

For example, it should be understood that the system and methodology of the present invention also can be applied to industrial concentrations of sodium hypochlorite solutions, 11% to 16% by weight, contained in drum sizes, 40 to 50 gallons, and tote sizes, 200 to 400 gallons. In such applications for making bleach blend, the quantity of additive is consistent with the aforementioned criterion. The usual practice for obtaining commercial-strength chlorine bleach products, e.g. sodium hypochlorite of about 6% by weight, is by diluting the industrial strength chlorine bleach product with an appropriate quantity of water. Following the same practice, industrial strength bleach blend diluted to a sodium hypochlorite concentration of about 6% by weight will automatically contain sodium hydroxide of about 3% by weight, thereby remaining consistent with the aforementioned criterion.

For tank sizes (4000-5000 gallons), the system and methodology of the present invention can either be applied at the initial stage of production of sodium hypochlorite or at the final (output) stage of production. Application at the initial stage of production of sodium hypochlorite is preferred in this embodiment, but modification of existing systems, pursuant to the teachings of the present invention, at any practical stage is envisioned.

In existing production of tank-size quantities of sodium hypochlorite, liquid chlorine is reacted with 50% by weight liquid sodium hydroxide. The quantities of these reactants are measured carefully so that the reaction is complete and minimal sodium hydroxide content remains in the product solution at the final stage, i.e., trace amounts as discussed. The product solution is diluted with quantities of water appropriate to obtain selective final concentrations of sodium hypochlorite between about 11% and about 16%, by weight, and with concentrations of sodium hydroxide less than 0.4%, by weight.

By the system and methodology of the present invention, this production technique is altered so that the sodium hydroxide starting ingredient is increased by an amount, in gallons or pounds, that blends with a selected final sodium hypochlorite concentration, such as to satisfy the aforementioned criterion for making bleach blend. For example, if the selected final sodium hypochlorite concentration is about 11% by weight, the resulting bleach blend solution will contain about 5.5% by weight sodium hydroxide; if the selected final concentration is about 16% by weight sodium hypochlorite, the resulting bleach blend solution also will contain about 8% by weight sodium hydroxide, and so forth. This is a preferred system and methodology for obtaining the composition of bleach blend in tank size quantities.

In another embodiment of the present invention, a system and methodology are described that will convert the process for the production of industrial-strength sodium hypochlorite (typically, 11% to 16% by weight), which when appropriately diluted makes chlorine bleach products of commercial strength, to a process for the production of similar industrial-strength sodium hypochlorite but in solution with sodium hydroxide, according to the aforementioned criterion, which when appropriately diluted makes stable, cotton-gentle bleach blend of commercial strength suitable for laundry use.

In the production of the sodium hypochlorite, liquid chlorine is reacted with 50% by weight liquid sodium hydroxide. By the system and methodology of the present invention, the sodium hydroxide starting ingredient is increased by an amount such that the final solution contains sodium hypochlorite plus sodium hydroxide according to the aforementioned criterion. For example, if the final solution contains about 11% by weight sodium hypochlorite, it also will contain about 5.5% by weight sodium hydroxide; if the final solution contains about 16% by weight sodium hypochlorite, it also will contain about 8% by weight sodium hydroxide, and so forth. The final industrial-strength solution is then appropriately diluted to the sodium hypochlorite concentration of about 6% by weight, which automatically results in the sodium hydroxide concentration of about 3% by weight, the composition of bleach blend, as per the aforementioned criteria.

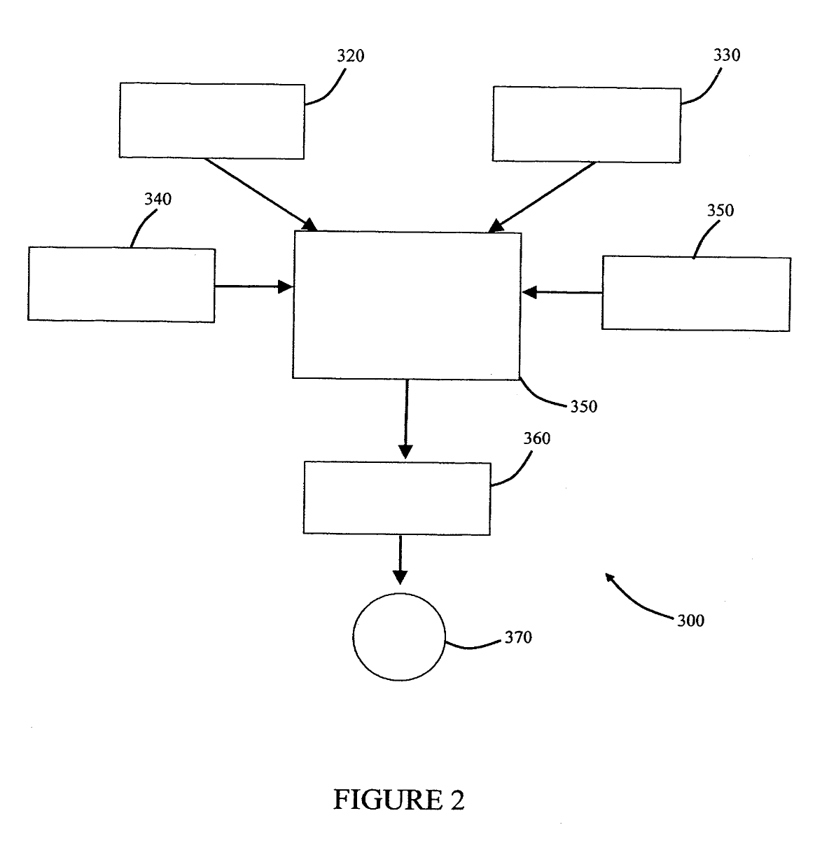

With reference now to FIG. 2 of the Drawings, there is illustrated therein a flowchart, generally designated by the reference numeral 300, of a system and methodology to practice aspects of the presently-claimed invention. In particular, various ingredients are added to a reactor 310, e.g., a first reactant 320 (a liquid chlorine solution), a second reactant 330 (50% liquid sodium hydroxide), an additive 340 (additional 50% liquid sodium hydroxide) for adjusting the resultant concentrations per the aforementioned criterion, and a solvent 350 (water), which may be used to dilute.

After admixture, the product solution preferably contains, e.g., by way of additive 340 adjustment, 12.5% sodium hypochlorite and 6.25% sodium hydroxide, by weight, i.e., the desired criterion, in water. As is understood in the art, some salt and metallic impurities precipitate out and are also caught in a filter 360. The resultant product or bleach blend is then collected, this final step being designated by the reference numeral 370. It should be understood that the above is an industrial grade admixture. It should, of course, also be understood that sufficient solvent 350 may be added to bring the aforedescribed percentages more in line with the desired commercial product, e.g., the sodium hypochlorite percentage, by weight, being about 5.25% to about 6%, which is safer for consumer usage.

It should be understood that although the above flowchart is principally directed to the preparation of large quantities of bleach blend in a large reactor, the principles are nonetheless applicable for a variety of reactor sizes and production quantities, and Applicant submits that systems, processes and kits that implement these principles are within the contemplation of the present invention, as discussed hereinabove. It should, of course, also be understood that the steps and ingredients may be altered to both simplify the implementation and make it sufficiently safe for consumer or other non-industrial usage.

Still other aspects, features, and advantages of the present invention are readily apparent from the following detailed description, simply by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

1. A conversion method for converting a commercial chlorine bleach product into a cotton-gentle bleach product, comprising:
measuring an effective amount of an additive, said additive comprising an alkali metal, and said commercial chlorine bleach product comprising a hypochlorite salt; and
admixing the additive into said commercial chlorine bleach product, wherein the alkali metal concentration by weight in the resultant product is about one-half the concentration by weight of the hypochlorite salt in the resultant product, whereby the resultant product is a cotton-gentle bleach product.

2. The conversion method according to claim 1, wherein said hypochlorite salt in said commercial chlorine bleach product comprises sodium hypochlorite, and wherein said alkali metal comprises sodium hydroxide.

3. The conversion method according to claim 2, wherein said sodium hypochlorite is about 5.25% to about 6% by weight.

4. The conversion method according to claim 1, wherein said additive is selected from the group consisting of sodium hydroxide beads and a liquid solution about 50% by weight sodium hydroxide.

5. The conversion method according to claim 1, wherein the concentration of said additive by weight is about one-half the concentration of the hypochlorite salt by weight in the resultant product.

6. A product produced by the conversion method of claim 1.

7. A kit for converting a commercial chlorine bleach product into a cotton-gentle bleach product, said kit comprising:
an additive and an instruction for measuring an effective amount of said additive, said additive comprising an alkali metal, and said commercial chlorine bleach product comprising a hypochlorite salt, wherein the alkali metal concentration by weight in the resultant product is about one-half the concentration by weight of the hypochlorite salt in the resultant product; and
a container, wherein said effective amount of said additive is admixed with a measured amount of said commercial chlorine bleach product therein, whereby the resultant product after admixture is a cotton-gentle bleach product.

8. The kit according to claim 7, wherein said hypochlorite salt in said commercial chlorine bleach product comprises sodium hypochlorite, and wherein said alkali metal comprises sodium hydroxide.

9. The kit according to claim 7, wherein said sodium hypochlorite is about 5.25% to about 6% by weight.

10. The kit according to claim 7, wherein said additive is selected from the group consisting of sodium hydroxide beads and a liquid solution about 50% by weight sodium hydroxide.

11. The kit according to claim 7, wherein the concentration of said additive by weight is about one-half the concentration of the hypochlorite salt by weight in the resultant product.

12. An additive, said additive used in converting a commercial chlorine bleach product comprising a hypochlorite salt into a resultant cotton-gentle bleach product, said additive comprising:
an alkali metal, an effective amount of said alkali metal being measured for admixture with said commercial chlorine bleach product, wherein the alkali metal concentration by weight in the resultant product is about one-half the concentration by weight of the hypochlorite salt in the resultant product, whereby said alkali metal when admixed with said commercial chlorine bleach product forms said cotton-gentle bleach product.

13. The additive according to claim 12, wherein said alkali metal is sodium hydroxide at about 2.625% to about 3% by weight in the resultant product.

14. The additive according to claim 12, wherein said hypochlorite salt in said commercial chlorine bleach product comprises sodium hypochlorite, and wherein said alkali metal comprises sodium hydroxide.

15. The additive according to claim 12, wherein said additive is selected from the group consisting of sodium hydroxide beads and a liquid solution about 50% by weight sodium hydroxide.

16. A method for producing a cotton-gentle bleach product, comprising:
measuring an amount of sodium hydroxide additive to add to a commercial chlorine bleach product, said commercial chlorine bleach product comprising sodium hypochlorite at about 5.25% to about 6.0% by weight, wherein the sodium hydroxide concentration by weight in the resultant product is about one-half the concentration by weight of the sodium hypochlorite in the resultant product; and
admixing said amount of sodium hydroxide additive to said commercial chlorine bleach product, whereby the resultant product is a cotton-gentle bleach product.

17. A product produced by the process of claim 16.

18. A kit for producing a cotton-gentle bleach product, said kit comprising:
a sodium hydroxide additive and an instruction for measuring an effective amount of said sodium hydroxide additive to add to a commercial chlorine bleach product, said commercial chlorine bleach product comprising sodium hypochlorite at about 5.25% to about 6.0% by weight, wherein the sodium hydroxide concentration by weight in the resultant product is about one-half the concentration by weight of the sodium hypochlorite in the resultant product; and
a container, wherein said effective amount of said sodium hydroxide additive is admixed with a measured amount of said commercial chlorine bleach product therein, whereby the resultant product is a cotton-gentle bleach product.

19. An additive, said additive used in converting a commercial chlorine bleach product into a cotton-gentle bleach product, said additive comprising:
a sodium hydroxide solution, an effective amount of said a sodium hydroxide additive being measured for admixture with said commercial chlorine bleach product, wherein said sodium hydroxide solution is at about 2.625% to about 3% by weight in the resultant product, and wherein the sodium hydroxide concentration in the resultant product is about one-half the concentration by weight of the sodium hypochlorite in the resultant product, whereby said sodium hydroxide solution when admixed with said commercial chlorine bleach product forms the resultant cotton-gentle bleach product.

20. A process for the production of a cotton-gentle bleach product, comprising:
determining an effective amount of sodium hydroxide to add to a liquid chlorine solution, wherein said sodium hydroxide concentration by weight in said resultant product is about one-half the concentration by weight of sodium hypochlorite formed in said resultant product; and
admixing said effective amount of sodium hydroxide to said liquid chlorine solution, forming said sodium hypochlorite.

21. The process according to claim 20, wherein the sodium hypochlorite concentration in the resultant product is at about 11% to about 16% by weight.

22. The process according to claim 20, further comprising the step of:
diluting -said admixture, said sodium hypochlorite in the resultant product being about 5.25% to about 6% by weight.

23. A product produced by the process of claim 20.

24. A system for the production of a cotton-gentle bleach product, comprising:
a sodium hydroxide additive and an instruction for measuring an effective amount of said sodium hydroxide additive to add to a liquid chlorine solution, wherein said sodium hydroxide concentration by weight in said amount is about one-half the concentration by weight of the sodium hypochlorite formed; and
a reactor, wherein said liquid chlorine is admixed with said sodium hydroxide therein, forming said sodium hypochlorite.

25. The system according to claim 24, wherein the sodium hypochlorite in said reactor is diluted to about 5.25% to about 6%, by weight, whereby the resultant product after dilution is said cotton-gentle bleach product.
